(19) United States
(12) Patent Application Publication
(10) Pub. No.: US 2009/0073710 A1
(43) Pub. Date: Mar. 19, 2009

(54) ILLUMINATION SYSTEM AND VEHICULAR HEADLAMP

(75) Inventors: Joseph Ludovicus Antonius Maria Sormani, Eindhoven (NL); Gunnar Luettgens, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,242

(22) PCT Filed: Nov. 14, 2005
(86) PCT No.: PCT/IB2005/053737

§ 371 Date: May 14, 2007

(30) Foreign Application Priority Data
Nov. 18, 2004 (EP) 04105868.6

(51) Int. Cl. F21V 1/00; F21V 9/00

(52) U.S. Cl. 362/509; 362/231

(57) ABSTRACT

An illumination system has a plurality of light-emitting diodes (R, G, B), at least one light-collimating section (12,12′) arranged along a longitudinal axis (25) of the illumination system. The light-collimating sections merges into a light-mixing section (3) having a plurality of side-faces along the longitudinal axis (25). Light propagation in the light-mixing section is based on total internal reflection. The light-mixing section is provided with a light-exit window (13) emitting light towards an imaginary projection surface normal to the longitudinal axis. An end-portion (5) of the light-mixing section is provided with a prismatic protrusion portion (7) for obtaining a light distribution at the imaginary projection surface such that illumination at a first part of the imaginary projection surface is relatively low while illumination at a second part of the imaginary projection surface is relatively high, the first part being obtained at the same side of the longitudinal axis as the prismatic protrusion portion of the light-mixing section.

The invention relates to an illumination system comprising a plurality of light-emitting diodes, at least one light-collimating section and a light-mixing section.

The invention further relates to a vehicular headlamp comprising this illumination system.

Such illumination systems are known per se. They are used, inter alia, as headlight for automotive vehicles. In addition, such illumination systems are used for general lighting purposes, such as so-called wall washers for creating an even spread of light on a (textured) wall surface. Other applications are in accent lighting, floodlights and for large-area direct-view light emitting panels such as applied, for instance, in signage, contour lighting, and billboards.

Generally, such illumination systems comprise a multiplicity of light-emitting diodes (LEDs). LEDs can be light sources of distinct primary colors, such as, for example the well-known red (R), green (G), or blue (B) light-emitting diodes. In addition, the light-emitting diode can have, for example, amber, magenta or cyan as primary color. These primary colors may be either generated directly by the light-emitting-diode chip, or may be generated by a phosphor upon irradiance with light from the light-emitting-diode chip. In the latter case, also mixed colors or white light is possible as one of the primary colors. Generally, the light emitted by the light-emitting diodes is mixed in the light-mixing section to obtain a uniform distribution of the light while eliminating the correlation of the light emitted by the illumination system to a specific light-emitting diode. In addition, it is known to employ a controller with a sensor and some feedback algorithm in order to obtain high color accuracy.

Present vehicular headlights typically employ filament-based light sources such as halogen lamps, or high-intensity discharge lamps that produce electric arc illumination by electrical discharge between electrodes in a high-pressure gas ambient. Such light sources produce a small source of light, which is collected and directed by optics typically including a back-reflector and a front lens. The optics preferably produce a beam that is forwardly directed in front of the vehicle, and a diameter, size or (complex-)shape back-reflector and/or lens controls the beam size of the headlight.

Vehicles normally have both a so-called high-beam and a so-called low-beam headlight, the former being used for providing maximum forward illumination and the latter being used when oncoming traffic is nearby, which is often the case in cities or other populated areas. The low-beam headlight is a compromise between providing forward illumination for the driver and avoiding glare and possible blinding of oncoming traffic by the vehicle headlights. The low-beam headlights are designed and mounted on the vehicle in a manner, which concentrates the low-beams below the horizontal, i.e. onto the road rather than toward oncoming traffic. The low-beam headlights are also preferably used in snowy, rainy, or foggy driving conditions to reduce back-scattered headlight illumination, which can blind the driver.

For the application of lamps in vehicle headlights, requirements for automotive passing beam patterns have been laid down. These (legal) requirements prescribe, amongst others, the creation of a relatively sharp so-called cut-off between the illuminated area and the glare area of the light beam emitted by the vehicle headlamp measured at a certain distance of the vehicle. In fact, the requirements prescribe a maximum illumination level in point/regions just above the cut-off and a minimum illumination level in point/regions just below the cut-off.

In the application of wall washers where a beam of light is emitted by a lamp positioned on or near ground level towards and along the wall of a building, it is desirable that the wall is evenly illuminated while preferably no light is directed towards the sky. Present day wall washers normally do not have a cut-off between a brightly illuminated wall while little or no light is emitted above the wall surface (into the sky).

US Patent Application US-A 2004/0076016 describes a wavelength conversion element for car use, which can provide practical LED components for headlights and fog lamps. The element comprises a heat conductive base having a cavity; one or more chips fitted to the cavity bottom, and a wavelength conversion part, which converts emitted light from the chip to visible rays, arranged above the chip. The chip comprises a substrate and a light emitting part constituted of an n-type GaN film, an active layer and a p-type GaN film successively laminated on the substrate. The chip has one straight side in its plane view; an angle formed between the bottom and the side cavity surface is over 0° and below 90°. The cavity has one straight side in its opening. A ratio of the cavity opening to the totaled areas in plan view of the respective chips, is set less than three.

A drawback of the known illumination system is that the contrast between the illuminated area and the glare area of the light beam emitted by the known illumination system is not sufficiently high.

The invention has for its object to eliminate the above disadvantage wholly or partly. According to the invention, this object is achieved by an illumination system comprising:

a plurality of light-emitting diodes,

at least one light-collimating section for collimating light emitted by the light-emitting diodes,

the at least one light-collimating section being arranged along a longitudinal axis of the illumination system,

the at least one light-collimating section merging into a light-mixing section at a side facing away -from the light-emitting diodes,

the light-mixing section having a plurality of side-faces along the longitudinal axis,

light propagation in the light-mixing section being based on total internal reflection,

the light-mixing section at a side facing away from the light-emitting diodes being provided with a light-exit window for. emitting light from the illumination system towards an imaginary projection surface arranged normal to the longitudinal axis,

an end-portion of the light-mixing section at a side facing away from the light-emitting diodes being provided with a prismatic protrusion portion, the light-mixing section widening at one pre-determined side along the longitudinal axis towards the light-exit window for obtaining a light distribution at the imaginary projection surface such that illumination at a first part of the imaginary projection surface is relatively low while illumination at a second part of the imaginary projection surface is relatively high,

the first part at the imaginary projection surface being obtained at the same side of the longitudinal axis as the prismatic protrusion portion of the light-mixing section.

According to the invention, the illumination system comprises a plurality of light-emitters, at least one light-collimating section and light-mixing section. If the light-mixing section was shaped normally, i.e. without the prismatic protrusion portion, the light would be emitted by the illumination system in a uniform manner whereby the imaginary projection surface would be uniformly illuminated, showing sharp cut-offs along all sides. By providing the end portion of the light-mixing section with a prismatic protrusion portion, the light-mixing section is given an asymmetric wedge-shape. By providing the end portion of the light-mixing section with a prismatic protrusion portion, the light distribution emitted by the illumination system becomes asymmetric, thereby changing a sharp cut-off into a smooth transition.

Light entering the light-mixing section and propagating in the light-mixing section under total internal reflection, is reflected against an outer surface of the light-mixing section without reaching the critical angle. In principle, all light rays in the light-mixing section propagate in a symmetric way towards the end portion of the light-mixing section. Due to the provision of the prismatic protrusion portion at the end portion of the light-mixing section, the light rays in the end portion no longer propagate in a symmetric manner. At this end portion the light-mixing section widens in one direction along the longitudinal axis towards the light-exit window of the light-mixing section. By providing the prismatic protrusion portion in this manner, light rays traveling towards the prismatic protrusion portion are no longer reflected by the outer surface of the light-mixing section but propagate directly towards the light-exit window of the light-mixing section and are coupled out of the light-mixing section at the light-exit window. Only the propagation of the light rays which enter the prismatic protrusion portion is altered by the provision of the prismatic protrusion portion. By providing the prismatic protrusion portion the light distribution of the light emitted by the illumination system is changed and becomes asymmetric.

If the light emitted by the illumination system according to the invention is projected on an imaginary projection surface, the illumination at the imaginary projection surface is no longer uniform but a separation in illuminance between parts of the imaginary projection surface is obtained. In particular, the illumination at a first part of the imaginary projection surface is relatively low while illumination at a second part of the imaginary projection surface is relatively high. At the side of the light-mixing section where the prismatic protrusion portion is provided, the illumination at the imaginary projection surface will be relatively dark while at the side where the light-mixing section is not provided with the prismatic protrusion portion the illumination at the imaginary projection surface will be relatively high. It is noted that the imaginary projection surface is introduced in the description and claims of this patent application only for elucidating the effect of the invention.

In the situation that the illumination system is arranged in a vehicle head light build in a vehicle traveling over a road surface, the prismatic protrusion portion is provided at a side of the light-mixing section facing away from the road surface. A light distribution at the imaginary projection surface is obtained wherein illumination at a lower part of the imaginary projection surface is relatively high while illumination at an upper part of the imaginary projection surface is relatively low. By providing the prismatic protrusion portion at a side of the light-mixing section facing away from the road surface, the light beam is concentrated below the horizontal, i.e. onto the road surface rather than toward oncoming traffic.

The illumination system according to the invention can be designed such that a relatively sharp cut-off between the illuminated area and the glare area of the light beam emitted by the illumination system is obtained. This is particularly required for vehicle headlamps where certain illumination levels are required measured at a certain distance of the vehicle. In particular, the requirements for vehicle headlamps prescribe a maximum illumination level in point/regions just above the cut-off and a minimum illumination level in point/regions just below the cut-off.

By providing the light-mixing section with a plurality of (substantially flat) side-faces arranged along the longitudinal axis, spatial mixing of the light emitted by the light-emitting diodes is stimulated. If the light-mixing section is provided with a substantially circular outer surface, this would be unfavorable for the spatial mixing of the light emitted by the light-emitting diodes. A preferred embodiment of the illumination system according to the invention is characterized in that the light-mixing section is provided with four or six side-faces. It was found that such a preferred number of side-faces stimulates spatial and spatio-angular mixing of the light emitted by the light-emitting diodes.

A preferred embodiment of the illumination system according to the invention is characterized in that a widening angle α of the prismatic protrusion portion relative to the longitudinal axis is chosen such that no light is reflected at an outer surface of the prismatic protrusion portion facing the light-exit window. The widening angle α is dependent on the angular distribution of the light upon entry into the light-mixing section. The broader the angular distribution upon entry into the light-mixing section, the larger the widening angle α has to be chosen to avoid reflection at the outer surface of the prismatic protrusion portion facing the light-exit window. The angular distribution of the light upon entry into the light-mixing section is determined by distribution of the light emitted by light-emitting diode and by the shape of the light-collimating section.

Preferably, the widening angle α of the prismatic protrusion portion is in the range from 10 to 35°. When the widening angle α is chosen too small (α<10°), the light-collimating sections become too long. On the other hand when the widening angle α is chosen too large (α>30°), the light distribution emitted by the illumination system becomes too broad to obtain the desired illumination in the imaginary projection surface. In a very favorable embodiment, the widening angle α is approximately 20°.

Preferably, the illumination system at a side facing away from the light-exit window is provided with a positive lens for projecting the light emitted by the illumination system. This lens provides that the light-exit window is projected by the illumination system.

The optics of the illumination system comprises the at least one light-collimating section for collimating the light emitted by the light-emitting diodes, the light-mixing section for mixing the light emitted by the at least one light-collimating section and the light-shaping diffuser. Preferably, the illumination system comprises a plurality of light-collimating sections arranged substantially parallel to each other along the longitudinal axis of the illumination system, each of the light-collimating sections being associated with at least one light-emitting diode. Each of the light-collimating sections is either associated with a single light-emitting diode or with a cluster of light-emitting diodes. A cluster of light-emitting diodes is either a group of light-emitting diodes with the same primary color or of a mix of primary colors.

Light in the light-collimating section or light-collimating sections may propagate in various manners. In one preferred embodiment, (internal) surfaces of the light-collimating sections are provided with a reflective material. In such an embodiment, the light-collimating sections are, preferably, filled with air. In yet another embodiment, light propagation in the light-collimating sections is based on total internal reflection. By basing the propagation of light emitted by the light-emitting diodes on total internal reflection (TIR), light losses in the light-collimating section are largely avoided. In such an embodiment, the light-collimating sections are, preferably, made of a non-gaseous, optically transparent dielectric material with a refractive index larger than or equal to 1.3.

These and other aspects of the invention are apparent from and will be elucidated with reference to the embodiments described hereinafter.

In the drawings:

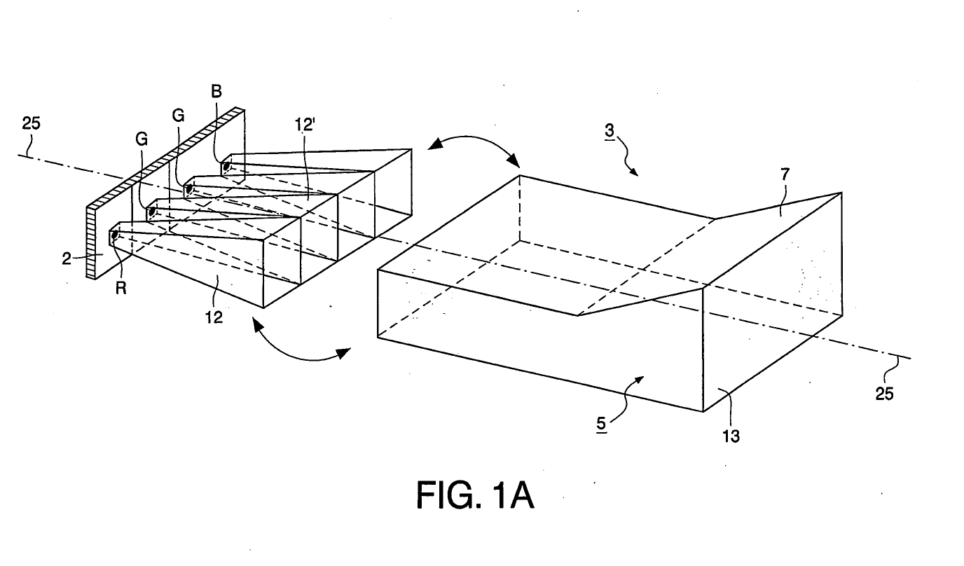

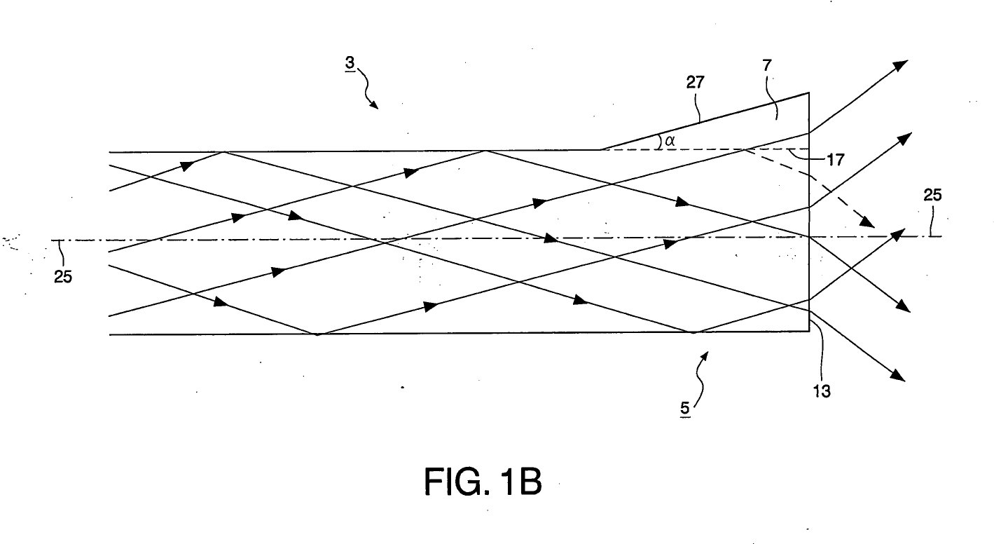

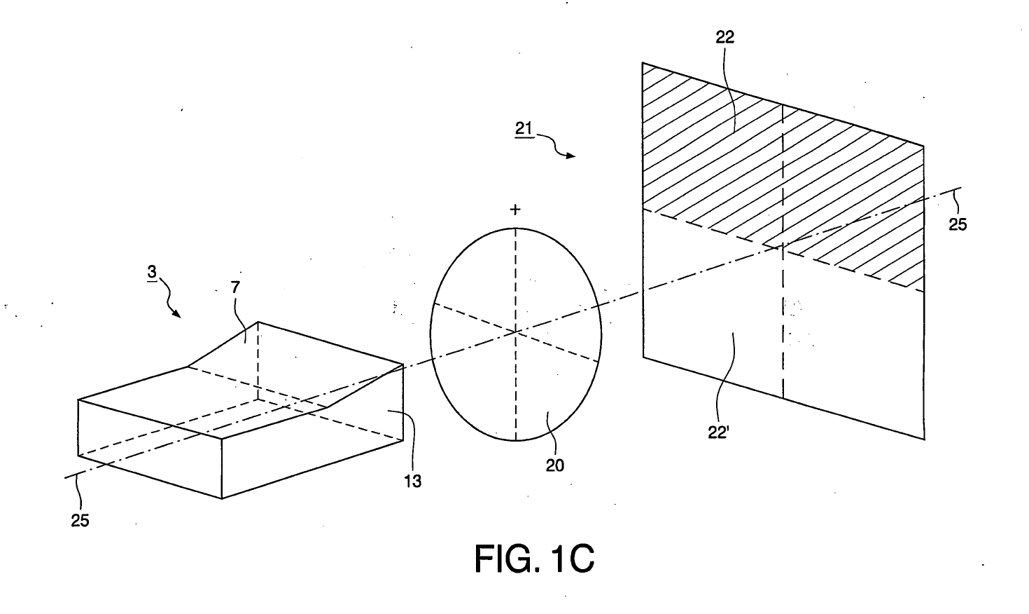

FIG. 1A is a perspective and exploded view of a first embodiment of the illumination system according to the invention;

FIG. 1B is a cross-sectional view of the light-mixing section of FIG. 1A;

FIG. 1C is a perspective view of the light-mixing section of FIG. 1A and the imaginary projection surface;

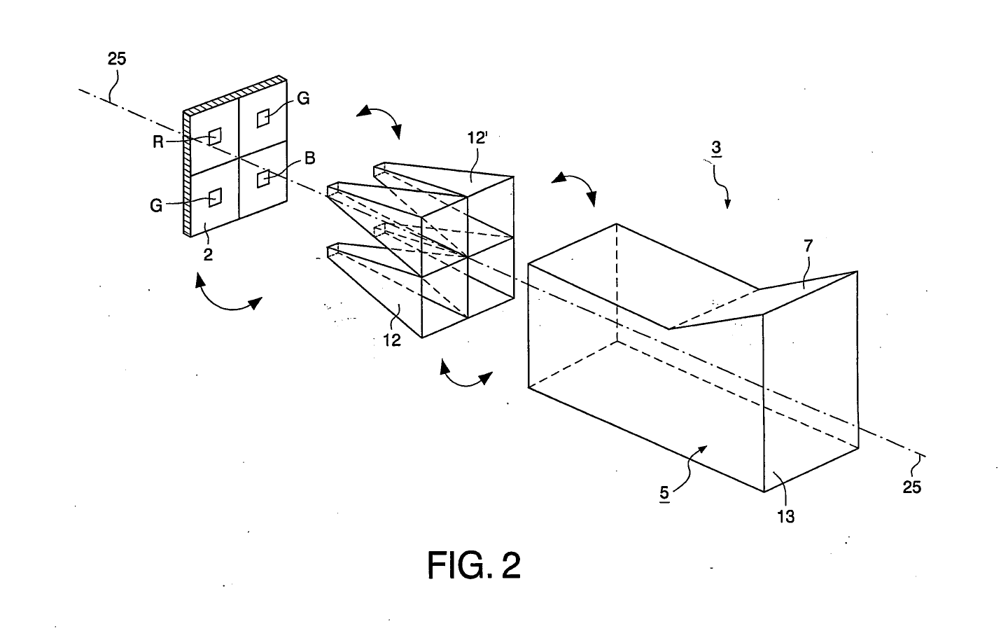

FIG. 2 is a perspective and exploded view of a second embodiment of the illumination system according to the invention, and

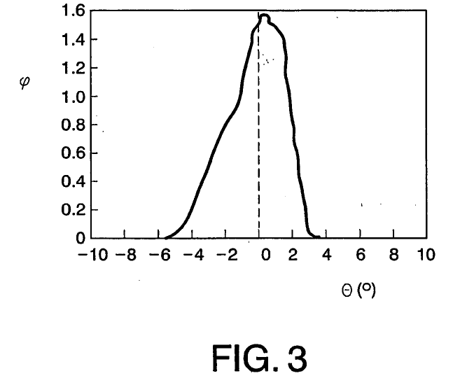

FIG. 3 shows a luminous intensity distribution φ as a function of the vertical angle of the light emitted by the illumination system according to the invention.

The Figures are purely diagrammatic and not drawn to scale. Notably, some dimensions are shown in a strongly exaggerated form for the sake of clarity. Similar components in the Figures are denoted as much as possible by the same reference numerals.

FIG. 1A very schematically shows a perspective and exploded view of a first embodiment of the illumination system according to the invention. FIG. 1B very schematically shows a cross-sectional view of the light-mixing section of FIG. 1A. FIG. 1C very schematically shows a perspective view of the light-mixing section of FIG. 1A and the imaginary projection surface. The illumination system comprises a plurality of light-emitting diodes (LEDs) R, G, B. LEDs can be light-emitting diodes of distinct primary colors, such as in the example of FIG. 1A, the well-known red R, green G, or blue B light-emitting diodes. In the example of FIG. 1A one red LED R, one blue LED B and two green LEDs G are arranged along a line. Alternatively, the light-emitting diode can have, for example, amber, magenta or cyan as primary color. The primary colors may be either generated directly by the light-emitting-diode chip, or may be generated by a phosphor upon irradiance with light from the light-emitting-diode chip. In the latter case, also mixed colors or white light is possible as one of the primary colors. In the example of FIG. 1A, the four LEDs R, G, G, B are mounted on a (metal-core) printed circuit board 2. In general, LEDs have relatively high source brightness. Preferably, each of the LEDs has a radiant power output of at least 25 mW when driven at nominal power and at room temperature of the LED junction generating the light. LEDs having such a high output are also referred to as LED power packages. The use of such high-efficiency, high-output LEDs has the specific advantage that a comparatively high light output with a relatively small number of LEDs. This has a positive effect on the compactness and the efficiency of the illumination system to be manufactured. If LED power packages are mounted on such a (metal-core) printed circuit board 2, the heat generated by the LEDs can be readily dissipated by heat conduction via the PCB. In a favorable embodiment of the illumination system, the (metal-core) printed circuit board 2 is in contact with a housing (not shown in FIG. 1) of the illumination system via a heat-conducting connection. Preferably, so-called naked-power LED chips are mounted on a substrate, such as for instance an insulated metal substrate, a silicon substrate, a ceramic or a composite substrate. The substrate provides electrical connection to the chip and acts as well as a good heat transportation section to transfer heat to a heat exchanger.

The embodiment of the illumination system as shown in FIG. 1A comprises a plurality of light-collimating sections 12, 12′ and a light-mixing section 3. The light-collimating sections 12, 12′ are arranged substantially parallel to each other along a longitudinal axis 25 of the illumination system. Each of the light-collimating sections 12, 12′ is associated with at least one light-emitting diode R, G, B. In the example of FIG. 1a single LED is associated with each respective light-collimating section. In an alternative embodiment there are more LEDs associated with each respective light-collimating section. This may be either a number of the LEDs with the same primary color or a number of LEDs with two or more primary colors.

In the example of FIG. 1A, the light-collimating sections 12, 12′ are filled with air. Light propagation in the light-colliimating sections 12, 12′ is based on reflection on reflective surfaces on sidewalls of the light-collimating sections 12, 12′. The light-collimating sections 12, 12′ at an exit surface at a side facing away from the light-emitting diodes R, G, B merge into the light-mixing section 3. For clarity reasons some space has been inserted in the drawing of FIG. 1A between the light-collimating sections 12, 12′ and the light-mixing section 3. By avoiding interface surfaces between the light-collimating sections and the light-mixing section, the efficiency of light propagation in the illumination system according to the invention is enhanced.

Light propagation in the light-mixing section 3 is based on total internal reflection (TIR) (see FIG. 1B). By basing the propagation of light emitted by the light emitters on TIR, light losses in the light-mixing section 3 are largely avoided. In addition, by providing the light-mixing section 3 with a plurality of (substantially flat) faces arranged parallel to the longitudinal axis, spatial mixing of the light emitted by the light emitters is stimulated. If the light-mixing section is provided with a substantially circular outer surface this would be unfavorable for spatial mixing of the light emitted by the light emitters.

Preferably, the light-mixing section 3 is provided with four or six faces. It was found that such a number of faces provides excellent spatial and spatio-angular mixing of the light emitted by the light emitters R, G, B.

The light-mixing section 3 at a side facing away from the light-emitting diodes R, G, B is provided with a light-exit window 13 for emitting light from the illumination system towards an imaginary projection surface 21 (see FIG. 1C) arranged normal to the longitudinal axis 25. The imaginary projection surface 21 is introduced in the description and claims of this patent application only to elucidate the effect of the invention.

According to the invention, an end-portion 5 of the light-mixing section 3 at a side facing away from the light-emitting diodes R, G, B is provided with a prismatic protrusion portion 7. The prismatic protrusion portion causes the light-mixing section 3 to widen at one pre-determined side along the longitudinal axis 25 towards the light-exit window 13. If the light-mixing section were shaped normally, i.e. without the prismatic protrusion portion, the light would be emitted by the illumination system in a uniform manner whereby the imaginary projection surface, would be uniformly illuminated. By providing the end portion 5 of the light-mixing section 3 with a prismatic protrusion portion 7, the light-mixing section 3 is given an asymmetric wedge-shape causing the light distribution emitted by the illumination system to become asymmetric.

Light emitted by the LEDs R, G, B, collimated in the light-collimating sections 12, 12′ and -entering the light-mixing section 3 is propagated in the light-mixing section 3 under total internal reflection. Light rays (see FIG. 1B) are reflected against an outer surface of the light-mixing section without reaching the critical angle. In principle, all light rays in the light-mixing section 3 propagate in a symmetric manner as long as the light rays do not enter the end portion 5 of the light-mixing section 3. The provision of the prismatic protrusion portion 7 at the end portion 5 of the light-mixing section 3 creates an asymmetric end portion 5 and disturbs the symmetric propagating of light rays in the end portion 5. Light rays traveling towards this prismatic protrusion portion 7 cross an imaginary boundary 17 (see FIG. 1B) between the light-mixing section 3 and the prismatic protrusion portion 7. These light rays are no longer reflected at this imaginary boundary 17 (see the dashed light rays in FIG. 1B) but propagate directly towards the light-exit window 13 of the light-mixing section (see FIG. 1B) and are coupled out of the light-mixing section 3 at the light-exit window. Only the propagation of the light rays, which enter the prismatic protrusion portion 7, is altered by the provision of the prismatic protrusion portion 7. By providing the prismatic protrusion, portion 7 the light distribution of the light emitted by the illumination system is changed and becomes asymmetric. At the light-exit window 13 less light is emitted in directions pointing downwards, i.e. light rays like the dashed light ray in FIG. 1B no longer occur, while more light is emitted in the upward direction, i.e. light rays emanating from the light-exit window 13 in the prismatic protrusion portion 7 are mainly directed upwards.

If the light emitted by the illumination system according to the invention is projected on an imaginary projection 21 surface (see FIG. 1C), the illumination at the imaginary projection surface 21 is no longer uniform but a separation in luminance between parts of the imaginary projection surface 21 is obtained. For projecting the light emitted by the illumination system, the illumination system further comprises a positive lens 20 arranged between the light-exit window 13 of the light-mixing section 3 and the imaginary projection surface 22. The effect of providing the prismatic protrusion portion 7 is that illumination at a first part 22 of the imaginary projection surface 21 is relatively low while illumination at a second part 22′ of the imaginary projection surface 21 is relatively high. At the side of the light-mixing section 3 where the prismatic protrusion portion 7 is provided, the illumination at the imaginary projection surface 21 is relatively dark (shaded part 22 of the imaginary projection surface 21) while at the side where the light-mixing section 3 is not provided with the prismatic protrusion portion 7 the illumination at the imaginary projection surface 21 is relatively high.

In FIG. 1B it is shown that the prismatic protrusion portion 7 widens with a widening angle α relative to the longitudinal axis 25 is chosen such that no light is reflected at an outer surface 27 of the prismatic protrusion portion 7 facing the light-exit window 13.

The widening angle α is dependent on the angular distribution of the light upon entry into the light-mixing section 3 and is largely determined by the angular distribution of the light emitted by the LEDs R, G, B and the widening characteristics of the light-collimating sections 12, 12′, i.e. the shape of the light-collimating section 12, 12′. The broader the angular distribution of the light upon entry into the light-mixing section 3, the larger the widening angle α has to be chosen to avoid reflection at the outer surface 27 of the prismatic protrusion portion 7 facing the light-exit window 13. Preferably, the widening angle α of the prismatic protrusion portion is in the range from 10 to 35°. When the widening angle α is chosen too small (α<10°), the light-collimating sections become too long. On the other hand when the widening angle α is chosen too large (α>30°), the light distribution emitted by the illumination system becomes too broad to obtain the desired illumination in the imaginary projection surface 21. In a very favorable embodiment, the widening angle α is approximately 20°.

FIG. 2 very schematically shows a perspective and exploded view of a second embodiment of the illumination system according to the invention. In this embodiment the LEDs R, G, G, B and the corresponding light-collimating sections 12, 12′, are positioned in a square-like arrangement. The shape of the light-mixing section 3 is adapted to meet the dimensions of the light-collimating sections 12, 12′.

FIG. 3 shows a luminous intensity distribution φ as a function of the vertical angle θ (in degrees) of the light emitted by the illumination system according to the invention. The characteristic shape of the luminous intensity distribution is obtained with a steep decrease in illumination at the right side of the θ=0° while a gradual decrease in illumination is obtained at the left side of the θ=0° in FIG. 3. This makes the illumination system very suitable for use as low-beam headlight where the design has to such that light is concentrated the low-beams below the horizontal, i.e. onto the road, while the oncoming traffic is not blinded by the headlight. The illumination system according to the invention fulfills the requirements for automotive passing beam patterns have been laid down. These (legal) requirements prescribe, amongst others, the creation of a relatively sharp so-called cut-off between the illuminated area and the glare area of the light beam emitted by the vehicle headlamp measured at a certain distance of the vehicle. A luminous intensity distribution emitted by an illumination system according to the invention as shown in FIG. 3 meets these requirements.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The. article “a” or “an” preceding an element does not exclude the presence of a plurality of such elements. The invention may be implemented by means of hardware comprising several distinct. elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An illumination system comprising:
a plurality of light-emitting diodes (R, G, B),
at least one light-collimating section (12, 12′) for collimating light emitted by the light-emitting diodes (R, G, B),
the at least one light-collimating section (12, 12′) being arranged along a longitudinal axis (25) of the illumination system,
the at least one light-collimating section (12, 12′) merging into a light-mixing section (3) at a side facing away from the light-emitting diodes (R, G, B),
the light-mixing section (3) having a plurality of side-faces along the longitudinal axis (25),
light propagation in the light-mixing section (3) being based on total internal reflection,
the light-mixing section (3) at a side facing away from the light-emitting diodes (R, G, B) being provided with a light-exit window (13) for emitting light from the illumination system towards an imaginary projection surface (21) arranged normal to the longitudinal axis (25),
an end-portion (5) of the light-mixing section (3) at a side facing away from the light-emitting diodes (R, G, B) being provided with a prismatic protrusion portion (7), the light-mixing section (3) widening at one pre-determined side along the longitudinal axis (25) towards the light-exit window (13) for obtaining a light distribution at the imaginary projection surface (21) such that illumination at a first part (22) of the imaginary projection surface (21) is relatively low while illumination at a second part (22′) of the imaginary projection surface (21) is relatively high,
the first part (22) at the imaginary projection surface (21) being obtained at the same side of the longitudinal axis (25) as the prismatic protrusion portion (7) of the light-mixing section (3).

2. An illumination system as claimed in claim 1, wherein a widening angle α of the prismatic protrusion portion (7) relative to the longitudinal axis (25) is chosen such that no light is reflected at an outer surface (27) of the prismatic protrusion portion (7) facing the light-exit window (13).

3. An illumination system as claimed in claim 2, wherein the widening angle α of the prismatic protrusion portion (7) is in the range from 10 to 35°.

4. An illumination system as claimed in claim 1, wherein the illumination system at a side facing away from the light-exit window (13) is provided with a positive lens (20) for projecting the light emitted by the illumination system.

5. An illumination system as claimed in claim 1, wherein the light-mixing section (3) is provided with four or six side-faces.

6. An illumination system as claimed in claim 1, wherein the illumination system comprises a plurality of light-collimating sections (12, 12′) arranged substantially parallel to each other along the longitudinal axis (25) of the illumination system, each of the light-collimating sections (12, 12′) being associated with at least one light-emitting diode (R, G, B).

7. An illumination system as claimed in claim 6, wherein light propagation in the light-collimating sections (12, 12′) is based on total internal reflection or on reflection on reflective surfaces (22) of the light-collimating sections (12, 12′).

8. An illumination system as claimed in claim 1, wherein the light-emitting diodes comprise at least a first light-emitting diode (R) of a first primary color, at least a second light-emitting diode (G) of a second primary color, and at least a third light-emitting diode (B) of a third primary color, the three primary colors being distinct from each other.

9. An illumination system as claimed in claim 8, wherein each of the light-emitting diodes (R, G, B) has a radiant power output of at least 25 mW when driven at nominal power and with the light-generating junction of the light emitting diodes (R, G, B) at room temperature.

10. A vehicular head lamp comprising an illumination system as claimed in claim 1.
